(19) United States
(12) Patent Application Publication
(10) Pub. No.: US 2016/0067987 A1
(43) Pub. Date: Mar. 10, 2016

(54) CUTTING APPARATUS AND PRINTING APPARATUS

(71) Applicant: CANON KABUSHIKI KAISHA, Tokyo (JP)

(72) Inventors: Takakazu Ohashi, Kawasaki-shi (JP); Ryohei Maruyama, Kawasaki-shi (JP); Daiki Anayama, Yokohama-shi (JP)

(21) Appl. No.: 14/847,348

(22) Filed: Sep. 8, 2015

(30) Foreign Application Priority Data
Sep. 9, 2014 (JP) 2014-183373

(51) Int. Cl. B41J 11/70; B26D 5/08; B26D 1/24

(52) U.S. Cl. CPC B41J 11/70; B26D 1/245; B26D 5/08

(57) ABSTRACT

A cutting apparatus comprising: a cutting unit with a rotary blade configured to cut an object by relatively moving an object and the rotary blade to each other in a cutting direction; and a changing unit configured to change a peripheral speed of the rotary blade while the object is being cut, wherein the changing unit sets the peripheral speed of the rotary blade during a first cutting operation from a start of cutting of the object until the object has been cut by a predetermined length, to be higher than the peripheral speed of the rotary blade during a second cutting operation in which the object is cut after the first cutting operation.

### BACKGROUND OF THE INVENTION

1. Field of the Invention

The present invention relates to a cutting apparatus and a printing apparatus both including a cutting device that cuts a cut medium.

2. Description of the Related Art

A cutting apparatus that cuts a cut medium using a single blade or a pair of blades is conventionally known. Such a cutting apparatus is mounted in, for example, a printing apparatus that houses a rolled print medium, and used as a device that cuts and separates a print medium with image data printed thereon into pages.

Japanese Patent Laid-Open No. H09-117891(1997) discloses a circle cutter that cuts a sheet by moving disc-like movable blades in a width direction of a sheet and that uses a simple configuration rotating the movable blades via a timing belt, to achieve a reduction in the size and weight of the cutter and in costs of the cutter.

A speed at which the cut medium is cut is referred to as a cutting speed, and a peripheral speed of a rotary blade is referred to as a rotary-blade peripheral speed. The configuration in Japanese Patent Laid-Open H09-117891 (1997) moves the timing belt to rotate rotary-blade rotating gears to transmit rotation of the rotary-blade rotating gears to the rotary blades. Thus, for the rotary blades forcibly rotated within a movement area of the rotary blades performing cutting, the cutting speed and the rotary-blade peripheral speed keep a one-to-one relation from beginning to end of the cutting.

When the rotary-blade peripheral speed is equivalent to or lower than the cutting speed, the rotary blades, upon coming into abutting contact with the cut medium, inappropriately bite into the cut medium. Then, the rotary blades fail to bite into the cut medium, and the cut medium is deformed starting at a position with which the rotary blades have come into abutting contact and is thus pushed in a cutting direction by the rotary blades, possibly leading to inappropriate cutting.

When the rotary-blade peripheral speed is lower than the cutting speed, sliding friction occurs between a cutting surface of the cut medium and the rotary blades, leading to a large amount of paper dust from the cutting surface of the cut medium. As a result, cutting quality is degraded. Sliding friction also occurs between the rotary blades, and cutting edges of the rotary blades may be worn off, degrading durability of the rotary blades.

When the cutting speed and the rotary-blade peripheral speed keep a one-to-one relation from beginning to end of the cutting as in the configuration in Japanese Patent Laid-Open No. H09-117891(1997), it is impossible to achieve both suppression of possible inappropriate cutting and suppression of degraded cutting quality and degraded durability of the rotary blades, resulting in a trade-off relation.

### SUMMARY OF THE INVENTION

Thus, an object of the present invention is to provide a cutting apparatus and a printing apparatus that allow suppression of degraded cutting quality and degraded durability of rotary blades while restraining possible inappropriate cutting.

A cutting apparatus comprises: a cutting unit with a rotary blade configured to cut an object by relatively moving an object and the rotary blade to each other in a cutting direction; and a changing unit configured to change a peripheral speed of the rotary blade while the object is being cut, wherein the changing unit sets the peripheral speed of the rotary blade during a first cutting operation from a start of cutting of the object until the object has been cut by a predetermined length, to be higher than the peripheral speed of the rotary blade during a second cutting operation in which the object is cut after the first cutting operation.

Further features of the present invention will become apparent from the following description of exemplary embodiments (with reference to the attached drawings).

### BRIEF DESCRIPTION OF THE DRAWINGS

FIG. 1 is a schematic sectional view depicting an ink jet printing apparatus according to a first embodiment;

FIG. 2 is a schematic block diagram depicting an embodiment of a control configuration;

FIG. 3 is a perspective view of a cutting apparatus according to the first embodiment;

FIG. 4 is a top view of an ink jet printing apparatus according to the first embodiment;

FIG. 5 is a schematic sectional view of a cutter unit according to the first embodiment as seen from above;

FIG. 6 is a schematic sectional view of the cutter unit according to the first embodiment as seen from behind;

FIG. 7 is a schematic sectional view of the cutter unit according to the first embodiment as seen from behind during cutting;

FIG. 8 is a schematic sectional view illustrating that the cutter unit is in a cutting start point position;

FIG. 9 is a diagram illustrating that the cutter unit has further moved in a cutting direction;

FIG. 10 is a schematic sectional view depicting the cutter unit; and

FIG. 11 is a schematic sectional view illustrating that the cutter unit has moved in the cutting direction.

### DESCRIPTION OF THE EMBODIMENTS

### First Embodiment

A first embodiment of the present invention will be described with reference to the drawings. The same reference numerals denote the same or corresponding components throughout the drawings.

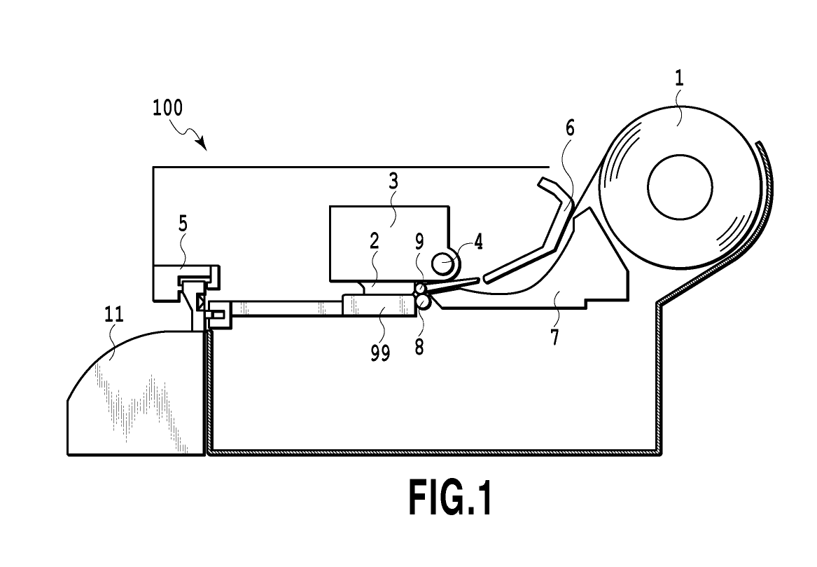

FIG. 1 is a schematic sectional view depicting an ink jet printing apparatus according to the first embodiment of the present invention. With reference to FIG. 1, a general configuration of the ink jet printing apparatus according to the present embodiment will be described. Rolled paper 1 held in an ink jet printing apparatus 100 is fed downstream through a conveying path including an upper guide 6 and a lower guide 7. When a leading end of the rolled paper 1 reaches a nip portion between a conveying roller 8 and a pinch roller 9, the rolled paper 1 is sandwiched between the conveying roller 8 and the pinch roller 9 and conveyed onto a platen 99 (image printing section) arranged opposite to a print head 2. The print head 2 ejects ink onto the rolled paper 1 conveyed to the image printing section to print an image on the rolled paper 1.

The image printing section includes the print head 2, a carriage 3 on which the print head 2 is mounted, and the platen 99 arranged opposite to the print head 2. The carriage 3 is slidably supported by the main body of the ink jet printing apparatus 100 along a carriage shaft 4 and a guide rail (not depicted in the drawings) arranged parallel to each other. The carriage 3 is configured to be able to reciprocate. Printing is performed by reciprocating the carriage 3 with the print head 2 mounted thereon and allowing the print head 2 to eject ink onto the rolled paper 1.

In the image printing section, when an image is printed by moving the carriage 3 forward or backward to scan one line, the conveying roller 8 and the pinch roller 9 feeds the rolled paper 1 by a predetermined pitch in a conveying direction. The carriage 3 is then moved again to print the next line of image. A printed portion of the rolled paper 1 is conveyed toward a sheet discharging guide 11. Such an operation is repeated to print an image on the rolled paper 1. When the image printing ends, the rolled paper 1 is conveyed to a predetermined cutting position where the rolled paper 1 is cut using a cutting apparatus 5. The cut rolled paper 1 is discharged to the exterior of the ink jet printing apparatus 100 through the sheet discharging guide 11.

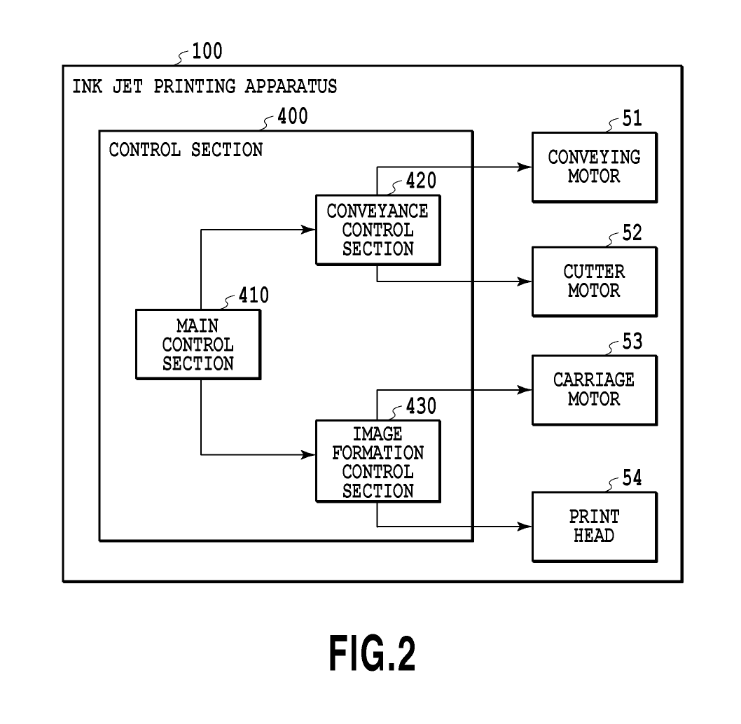

FIG. 2 is a schematic block diagram depicting an embodiment of a control configuration of the ink jet printing apparatus 100. With reference to FIG. 2, the control configuration according to the present invention will be described in brief. A control section 400 is provided on the ink jet printing apparatus 100. The control section 400 achieves control of a conveying motor 51, a cutter motor 52, a carriage motor 53, and a print head 54. The control section 400 also includes a CPU, a ROM, a RAM, and a motor driver not depicted in the drawings, and further includes a main control section 410, a conveyance control section 420, and an image formation control section 430.

The main control section 410 gives instructions to the conveyance control section 420 and the image formation control section 430. Based on determination by the main control section 410, the conveyance control section 420 drives the conveying motor 51 to operate conveying devices such as the conveying roller 8 to convey the rolled paper 1, and drives the cutter motor 52 to cut the rolled paper 1. The image formation control section 430 allows the carriage motor 53 and the print head 2 to cooperate with each other in forming an image at an appropriate position on the rolled paper 1.

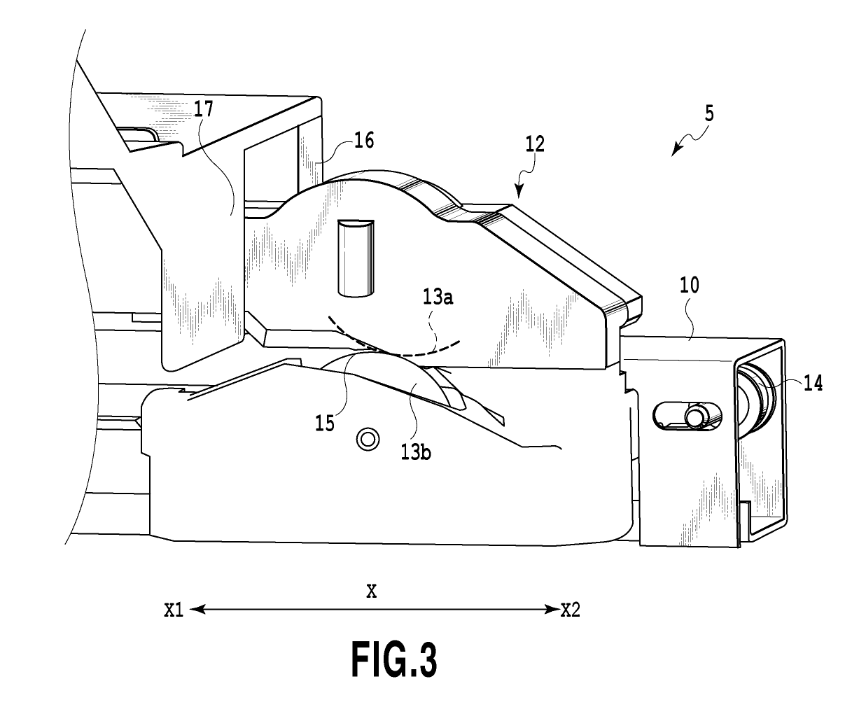

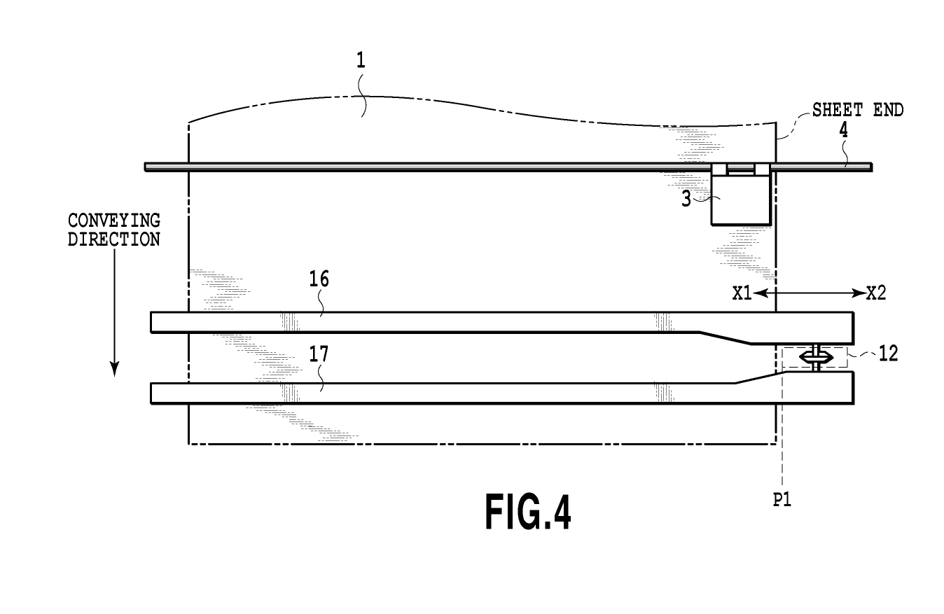

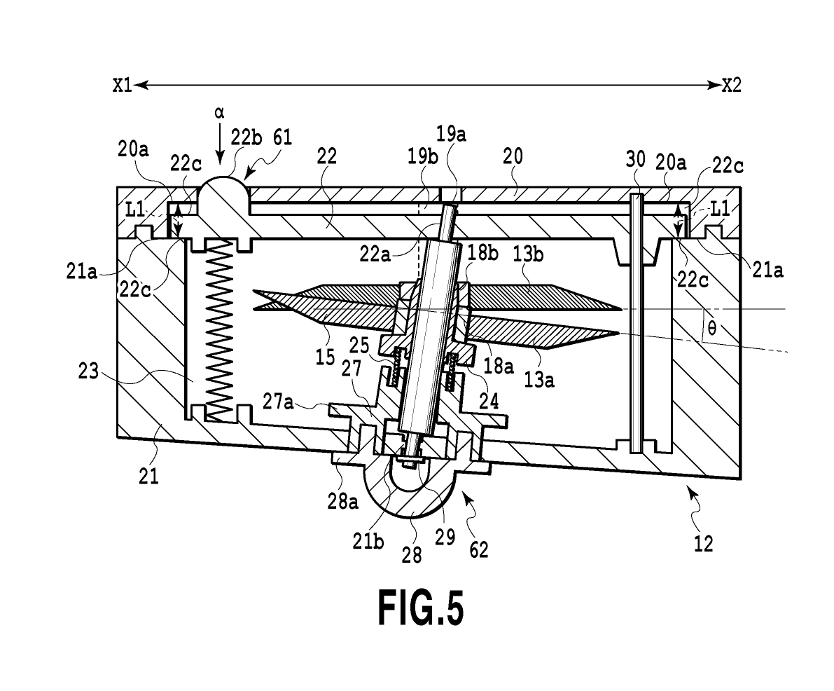

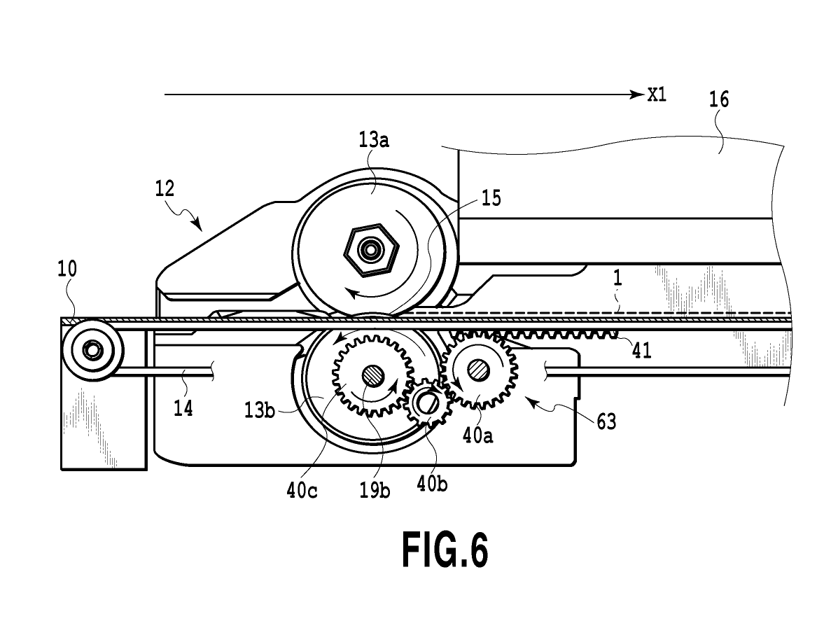

FIG. 3 is a perspective view depicting the cutting apparatus according to the present invention. FIG. 4 is a top view of the ink jet printing apparatus according to the present invention. FIG. 5 is a schematic sectional view of a cutter unit according to the present invention as seen from above. FIG. 6 is a schematic sectional view of the cutter unit according to the present invention as seen from behind, depicting a rotary-blade rotating device that rotates a lower movable blade when the cutter unit is in a cutting start point position.

Now, the cutting apparatus according to the present invention will be described with reference to FIG. 3, FIG. 4, FIG. 5, and FIG. 6.

A cutting apparatus 5 has a cutter unit 12, a guide rail 10, and a belt 14. The guide rail 10 is configured to guide the cutter unit 12 in a direction orthogonal to the conveying direction of the rolled paper 1. The cutter unit 12 can be reciprocated along the guide rail 10 in the direction X1 and direction X2 of arrow X by a driving force transmitted from the cutter motor 52, which is a driving section, via the belt 14. The cutter unit 12 stands by in a standby position P1 (see FIG. 4) where the cutter unit 12 is away from an end of the rolled paper 1 while image formation is being performed on the rolled paper 1.

When the rolled paper 1 is cut, the cutter unit 12 moves in the cutting direction X1, which is the direction for cutting, from the standby position P1 to cut the rolled paper 1 (object). After the rolled paper 1 is cut, the cutter unit 12 moves in the direction X2 without performing a cutting operation and stands by in the standby position P1 until the next cutting operation.

As depicted in FIG. 5 and FIG. 6, the cutter unit 12 includes an upper movable blade 13a, a lower movable blade 13b, a crossing angle changing device 61, a pressing force changing device 62, and a rotary-blade rotating rotary-blade rotating device 63. The upper movable blade 13a is a rotatable disc-like (circular) blade disposed above a surface of the rolled paper 1 on which an image is formed and including a peripheral blade. The lower movable blade 13b is rotatable disc-like circular blade disposed below a back surface of the rolled paper 1 that is opposite to the surface on which the image is formed and including a peripheral blade. The lower movable blade 13b cooperates with the upper movable blade 13a in cutting the object. The lower movable blade 13b has a surface substantially parallel to the cutting direction.

On the other hand, the blade of the upper movable blade 13a has a surface inclined to the cutting direction and subtends a predetermined angle θ (crossing angle θ) to the cutting direction X1. Specifically, a standby position P1 side of the upper movable blade 13a is disposed on a downstream side with respect to the lower movable blade 13b in the conveying direction of the rolled paper 1. The side of the upper movable blade 13a opposite to the standby position P1 side is partly disposed on an upstream side with respect to the lower movable blade 13b in the conveying direction of the rolled paper 1. The upper movable blade 13a is pressed against the lower movable blade 13b at a predetermined angle θ (crossing angle θ) to the cutting direction X1. The upper movable blade 13a thus comes into point contact with the lower movable blade 13b and is rotatably held. In other words, the upper movable blade 13a is pressed against the lower movable blade 13b at the predetermined angle θ (crossing angle θ).

The contact point between the upper movable blade 13a and the lower movable blade 13b corresponds to a cutting point 15. The upper movable blade 13a and the lower movable blade 13b rotate while in contact with each other at the cutting point 15. Consequently, the cutter unit 12 moves in the cutting direction X1 with the rolled paper 1 held, cutting the rolled paper 1. When the rolled paper 1 is cut, the cutter unit 12 moves in the cutting direction X1 to rotate the upper movable blade 13a and the lower movable blade 13b in a direction in which the rolled paper 1 is drawn into the cutting point 15, and moves in the direction X1 as depicted in FIG. 6.

A bearing 18a and a bearing 18b are fixed with an adhesive or the like to the vicinities of the centers of rotation of the upper movable blade 13a and the lower movable blade 13b, respectively. The bearings reduce rotating loads on the upper movable blade 13a and the lower movable blade 13b. The upper movable blade 13a and the lower movable blade 13b rotate around an upper movable blade rotating shaft 19a and a lower movable blade rotating shaft 19b, respectively, via the bearings.

As depicted in FIG. 5, the crossing angle changing device 61 includes an upstream side holding portion 20, a downstream side holding portion 21, a slide member 22, a slide pressing spring 23, and a slide rail shaft 30. The crossing angle changing device 61 allows the crossing angle θ of the upper movable blade 13a to be changed. A groove portion 22a is formed in the slide member 22 to pivotally support one side of the upper movable blade rotating shaft 19a. A groove portion 21b is formed in the downstream side holding portion 21 to pivotally support the other side of the upper movable blade rotating shaft 19a. That is, the groove portion 22a formed in the slide member 22 and the groove portion 21b formed in the downstream side holding portion 21 pivotally support the upper movable blade rotating shaft 19a.

The groove portion 22a in the slide member 22 is arranged behind and at a predetermined distance from the groove portion 21b in the downstream side holding portion 21 such that the upper movable blade rotating shaft 19a is inclined to a direction orthogonal to the cutting direction X1. Thus, the upper movable blade 13a is inclined at the predetermined angle (crossing angle) θ to the cutting direction X1. That is, the upper movable blade rotating shaft 19a, the groove portion 21b in the downstream side holding portion 21, and the groove portion 22a in the slide member 22 set the crossing angle θ.

A thrust suppressing portion 29 is attached to an end of the downstream side holding portion 21 of the upper movable blade rotating shaft 19a to prevent the upper movable blade rotating shaft 19a from slipping out from the downstream side holding portion 21. The slide rail shaft 30 is pivotally supported in a direction substantially orthogonal to the cutting direction X1 by the upstream side holding portion 20 and the downstream side holding portion 21. The slide member 22 includes an abutting contact portion 22c arranged in a slide area L1 sandwiched between a retaining portion 20a of the upstream side holding portion 20 and a sliding suppressing portion 21a of the downstream side holding portion 21. In the above-described arrangement, the slide member 22 can slide on the slide rail shaft 30 within the slide area L1.

The slide member 22 is biased, by the slide pressing spring 23 held by the slide member 22, in a direction in which the slide member 22 presses the abutting contact portion 22c against the retaining portion 20a of the upstream side holding portion 20. The slide member 22 also has a contact portion 22b that partly protrudes from the upstream side holding portion 20 and in which the protruding part is shaped like a circular arc at a leading end of thereof. Pushing in the contact portion 22b in the direction of arrow α moves the slide member 22 within the slide area L1.

When the slide member 22 moves within the slide area L1, the upper movable blade rotating shaft 19a is tilted around the groove portion 21b in the downstream side holding portion 21 so as to change the inclination of the upper movable blade rotating shaft 19a to the direction orthogonal to the cutting direction X1. This changes the crossing angle θ of the upper movable blade 13a. When the cutter unit 12 reciprocates, the upstream side holding portion 20 and the downstream side holding portion 21 are guided with respect to the guide rail 10 depicted in FIG. 3.

When the abutting contact portion 22c of the slide member 22 maximally approaches the sliding preventing portion 21a of the downstream side holding portion 21 (as depicted in FIG. 5), the crossing angle θ is maximized. In contrast, the abutting contact portion 22c of the slide member 22 maximally approaches the retaining portion 20a of the upstream side holding portion 20, the crossing angle θ is minimized. Thus, moving the slide member 22 enables a change in the crossing angle, which is the angle of the upper movable blade 13a to the cutting direction X1. In other words, while the rolled paper 1 is being cut, moving the slide member 22 enables the crossing angle θ to be changed even while the rolled paper 1 is being cut.

The crossing angle θ is an element related to a cutting property, and an increase in crossing angle θ allows the blades to appropriately bite into a sheet at the start of cutting (cutting performance). However, an increase in crossing angle θ leads degraded cutting quality such as a large amount of paper dust from a cutting surface of the rolled paper 1 being cut or deteriorated durability of the blades. Thus, the quality of cutting surface of the paper (cutting quality) is enhanced by reducing the crossing angle at a predetermined timing after the start of the cutting.

The pressing force changing device 62 includes a spring holder 24, a pressing spring 25, an external holder 27, and a pressing device 28. The pressing force changing device 62 enables a change in a pressing force F exerted on the lower movable blade 13b by the upper movable blade 13a. The spring holder 24 is attached around the upper movable blade rotating shaft 19a so as to contact an inner ring portion of the bearing 18a of the upper movable blade 13a. The pressing spring 25 is held by the external holder at one end of the pressing spring 25 and by the spring holder 24 at the other end of the pressing spring 25. The pressing spring 25 presses the upper movable blade 13a against the lower movable blade 13b via the spring holder 24 and the bearing 18a of the upper movable blade 13a.

The external holder 27 is coupled to the pressing member 28 on a side thereof opposite to a side thereof that holds the pressing spring 25. The downstream side holding portion 21 is sandwiched between a thrust suppressing portion 27a of the external holder 27a and a thrust suppressing portion 28a of the pressing member 28. The external holder 27 is slidable with respect to the downstream side holding portion 21. The external holder 27 moves via the pressing member 28 to change an operating length of the pressing spring 25, thus changing the pressing force F exerted on the lower movable blade 13b by the upper movable blade 13a.

When the thrust suppressing portion 28a of the pressing member 28 maximally approaches the downstream side holding portion 21 (as depicted in FIG. 5), the pressing force F exerted on the lower movable blade 13b by the upper movable blade 13a is maximized. In contrast, when the thrust suppressing portion 27a of the external holder 27 maximally approaches the downstream side holding portion 21, the pressing force F exerted on the lower movable blade 13b by the upper movable blade 13a is minimized. Thus, moving the external holder 27 via the pressing member 28 enables a change in the pressing force F exerted on the lower movable blade 13b by the upper movable blade 13a. In other words, moving the external holder 27 via the pressing member 28 during the cutting of the rolled paper 1 enables a change in the pressing force F exerted on the lower movable blade 13b by the upper movable blade 13a even during the cutting of the rolled paper 1.

The pressing force F is an element related to the cutting property. An increase in pressing force F allows suppression of inappropriate cutting resulting from separation of the blades caused by cutting resistance from the sheet; the inappropriate cutting is likely to occur near the end of the rolled paper 1 at the start of the cutting. However, increasing the pressing force F causes the blades to be worn off, degrading the durability of the upper movable blade 13a and the lower movable blade 13b. Thus, at a predetermined timing after the start of the cutting, the pressing force is reduced to suppress degraded durability of the blades.

As depicted in FIG. 6, the rotary-blade rotating device 63 is provided in the cutter unit 12 and includes a rotation input gear 40a, a driven gear 40b, and a rotary blade rotating gear 40c. In the rotary-blade rotating device 63, the rotation input gear 40a meshes with a rack member 41 provided on the guide rail 10 to move relative to the guide rail 10, thus forcibly rotating the lower movable blade 13b. The rotation input gear 40a meshes with the rack member 41 provided on the guide rail 10 and is thus forcibly rotated in conjunction with movement of the cutter unit 12.

The driven gear 40b transmits rotation of the rotation input gear 40a to the rotary blade rotating gear 40c. The rotary blade rotating gear 40c is integrally attached to the lower movable blade 13b such that the lower movable blade rotating shaft 19b corresponds to a central axis, so that the rotary blade rotating gear 40c can rotate integrally with the lower movable blade 13b. Forcibly rotating the rotary blade rotating gear 40c also rotates the lower movable blade 13b. In an area where the rack member 41 is not provided, the rotary blade rotating gear 40c does not mesh with the rack member 41 and thus does not rotate.

That is, within a movement area of the cutter unit 12, different areas are provided: the area where the rotation input gear 40a meshes with the rack member 41 and the area where the rotation input gear 40a does not mesh with the rack member 41. Consequently, the rotary-blade rotating device 63 enables switching between an area where the lower movable blade 13b is forcibly rotated and an area where the lower movable blade 13b is not rotated.

A moving speed of the cutter unit 12 is represented as a cutting speed V1. A peripheral speed of the lower movable blade 13b is represented as a peripheral speed V2. As the cutter unit 12 moves, the rotation input gear 40a, the driven gear 40b, and the rotary blade rotating gear 40c are forcibly rotated at a peripheral speed equal to the cutting speed V1 in the direction of an arrow in FIG. 6. Rotation of the rotary blade rotating gear 40c rotates the lower movable blade 13b, which rotates integrally with the rotary blade rotating gear 40c.

The pitch circle diameter of the rotary blade rotating gear 40c<the diameter of the lower movable blade 13b, and thus, the peripheral speed V2 of the lower movable blade 13b is higher than the cutting speed V1. In the present embodiment, the lower movable blade 13b has a diameter of 24 mm, and the rotary blade rotating gear 40c has a pitch circle diameter of 12 mm. Thus, the peripheral speed V2 of the lower movable blade 13b is approximately 2×V1, that is, approximately twice as high as the cutting speed V1, that is, the moving speed of the cutter unit 12. The speed of a cutting edge relative to the rolled paper 1 is approximately 2×V1, which is equal to the peripheral speed V2 of the lower movable blade 13b.

On the other hand, in the area where the rack member 41 is not provided, the lower movable blade 13b is not rotated by the rack member 41. However, when the rolled paper 1 is cut, the upper movable blade 13a and the lower movable blade 13b are moved at the cutting speed V1 equal to the moving speed of the cutter unit 12, while cutting the rolled paper 1. Thus, the upper movable blade 13a and the lower movable blade 13b rotate as a result of a frictional force between the rolled paper 1 and the blades.

Consequently, when the rolled paper 1 is cut in the area where the rack member 41 is not provided, the upper movable blade 13a and the lower movable blade 13b rotate at the peripheral speed V2 approximately equal to the cutting speed V1 corresponding to the moving speed of the cutter unit 12. The speed of the cutting edge relative to the rolled paper 1 is approximately equal to the cutting speed V1, which is in turn equal to the peripheral speed V2 of the lower movable blade 13b.

On the other hand, when the rolled paper 1 is not being cut in the area where the rack member 41 is not provided, no force that rotates the lower movable blade 13b is obtained, and thus, the peripheral speed V2 of the lower movable blade 13b is zero. Consequently, the upper movable blade 13a and the lower movable blade 13b do not rotate. The speed of the cutting edge relative to the rolled paper 1 is zero, which is equal to the peripheral speed V2 of the lower movable blade 13b. The case where the rolled paper 1 is not being cut occurs during a moving operation in the cutting direction X1 after the cutting of the rolled paper 1 ends and during a moving operation in the direction X2 when the cutter unit 12 returns to the standby position P1.

While the rolled paper 1 is not being cut, the upper movable blade 13a is rotated in conjunction with rotation of the lower movable blade 13b as a result of friction between the upper movable blade 13a and the lower movable blade 13b. The upper movable blade 13a rotates at a speed lower than the peripheral speed V2 of the lower movable blade 13b. As described above, when a cutting path for the rolled paper 1 includes different parts: the part where the rack member 41 is provided and the part where the rack member 41 is not provided, the peripheral speed V2 of the lower movable blade 13b can be switched during cutting of the rolled paper 1.

In cutting using a disc-like circular blade, the peripheral speed, which is equal to the speed of the cutting edge relative to the rolled paper 1, is an element related to the cutting property. An increase in peripheral speed allows the blades to appropriately bite into the sheet. On the other hand, increasing the peripheral speed leads to degraded cutting quality such as a large amount of paper dust from the cutting surface or degraded durability of the blades.

When the peripheral speed V2 of the lower movable blade 13b is increased with respect to the moving speed, an effect is enhanced which causes the rolled paper 1 to be drawn into the cutting point 15 between the upper movable blade 13a and the lower movable blade 13b. This is effective for enabling the blades to more appropriately bite into the sheet.

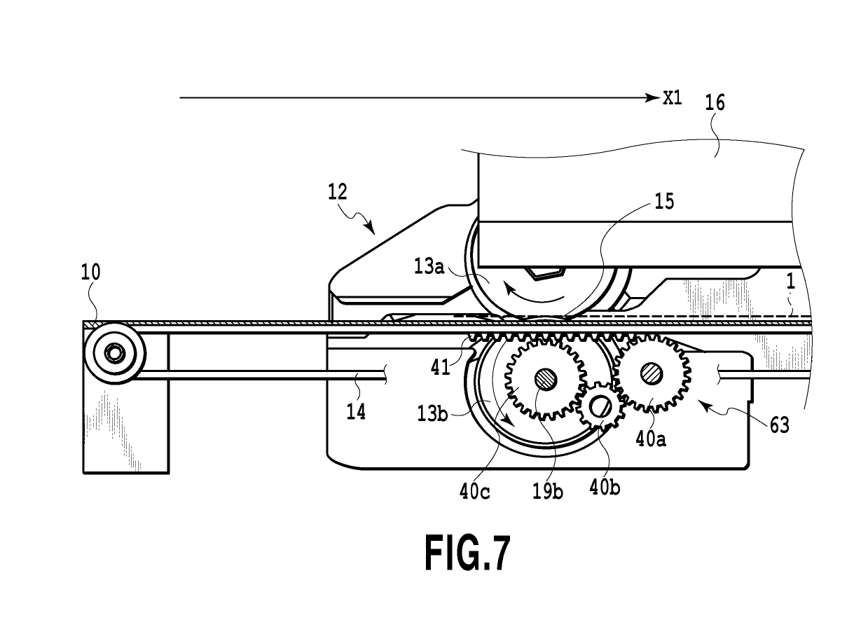

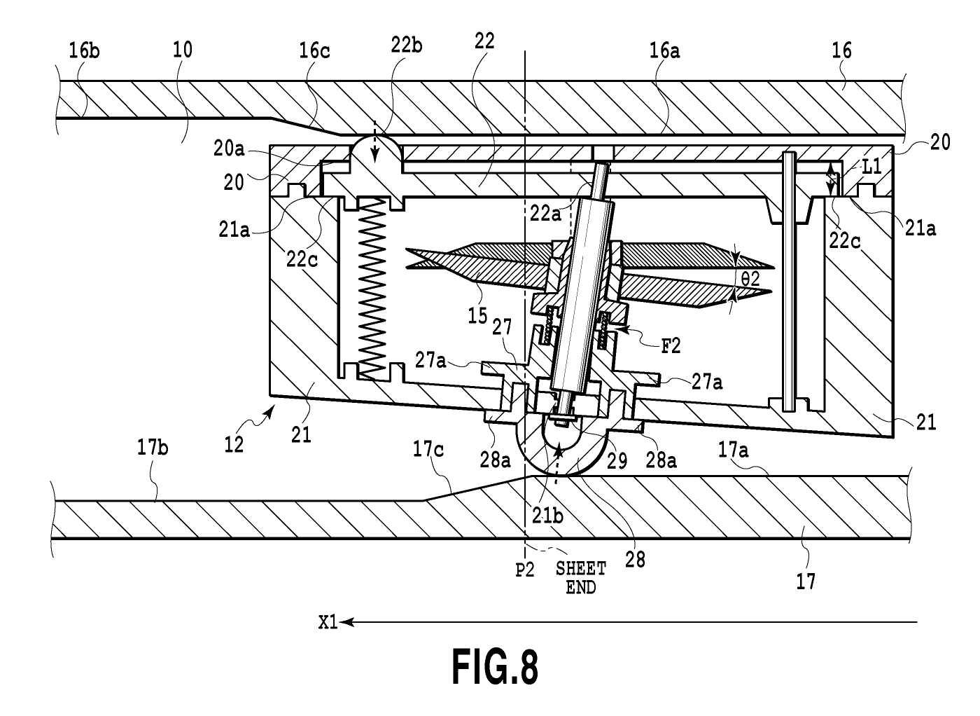

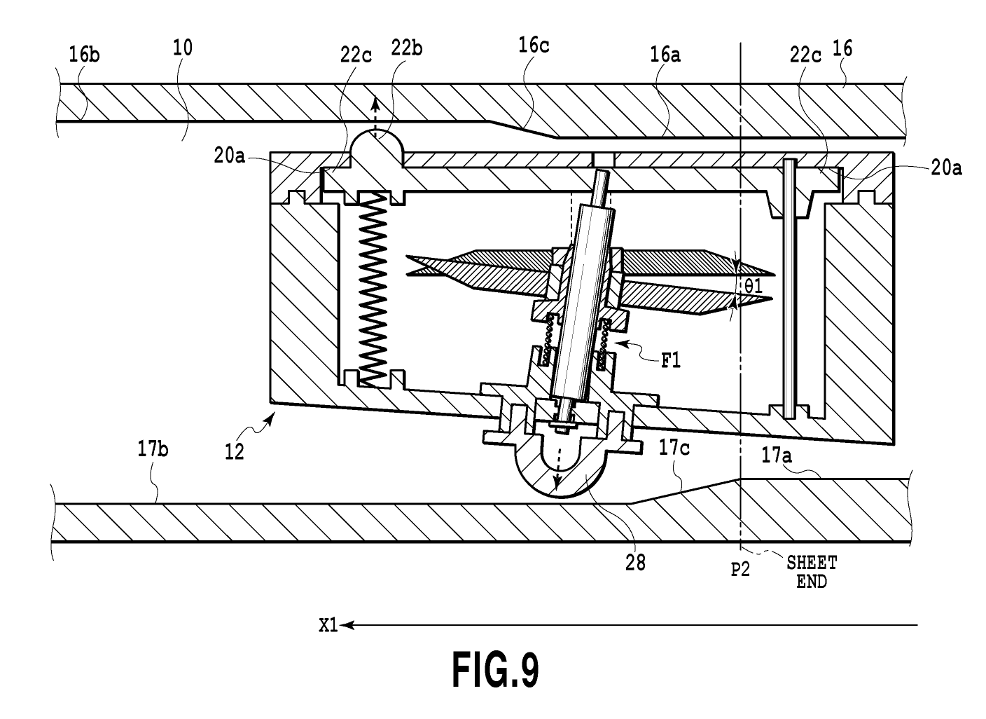

FIG. 7 is a schematic sectional view of the cutter unit 12 according to the present invention during cutting as seen from behind, illustrating that the cutter unit 12 in the state illustrated in FIG. 6 has moved in the cutting direction X1 and depicting the rotary-blade rotating device rotating the lower movable blade 13b while the cutter unit is in the position of cutting. FIG. 8 is a schematic sectional view of the cutter unit according to the present invention in a cutting start point position as seen from above. FIG. 9 is a schematic sectional view depicting a state where the cutter unit in the state illustrated in FIG. 8 has further moved in the cutting direction X1 and where the cutter unit according to the present invention is in the position of cutting, as seen from above.

Now, with reference to FIG. 6, FIG. 7, FIG. 8, and FIG. 9, the operation of the cutter unit 12 changing cutting conditions during cutting by the cutting apparatus according to the present invention will be described in conjunction with effects of an upstream support member 16, effects of a downstream support member 17, and effects of the rack member 41.

The upstream support member changes the crossing angle θ of the upper movable blade 13a to the lower movable blade 13b. As depicted in FIG. 7, the upstream support member 16 is arranged above a surface of the rolled paper 1 on which the image is printed. The upstream support member 16 controls the position of the slide member 22 via the contact portion 22b of the cutter unit 12 to change the crossing angle θ of the upper movable blade 13a to the lower movable blade 13b. As depicted in FIG. 8, the upstream support member 16 includes a first flat surface (protruding portion) 16a that is a surface protruding in the conveying direction, which is orthogonal to the cutting direction X1, a second flat surface 16b that is a surface retracted at a predetermined distance from the first flat surface 16a in the conveying direction, and a slope portion 16c that joins the first flat surface 16a and the second flat surface 16b together.

The first flat surface 16a protrudes to the degree that the contact portion 22b is pushed to bring the abutting contact portion 22c of the slide member 22 nearly into contact with the sliding suppressing portion of the downstream side holding portion 21. As depicted in FIG. 8, when the contact portion 22b is in a position corresponding to the first flat surface 16a in the cutting direction, that is, when the cutter unit 12 is in a position where the contact portion 22b is pushed in by the first flat surface 16a, the crossing angle θ of the upper movable blade 13a to the cutting direction X1 is maximized (crossing angle θ=θ2). At a crossing angle θ=θ2 where the crossing angle θ is maximized, the blades appropriately bite into the sheet. This prevents a situation where, when the cutting point 15 between the upper movable blade 13a and the lower movable blade 13b passes through a cutting start point P2 for the rolled paper 1, the blades fail to bite into the sheet, which is then deformed.

The second flat surface 16b is provided on a traveling direction side (opposite to the standby position P1) in the cutting direction during cutting with respect to the first flat surface 16a. The second flat surface 16b is retracted to the degree that, with the abutting contact portion 22c of the slide member 22 in contact with the retaining portion 20a of the upstream side holding portion 20, the contact portion 22b of the slide member 22 does not contact the second flat surface 16b. That is, as depicted in FIG. 9, when the contact portion 22b is in the position corresponding to the second flat surface 16b in the cutting direction, the cutter unit 12 is not pushed in because the contact portion 22b of the slide member 22 does not contact the second flat surface 16b. At this time, the spring bias force of the slide pressing spring 23 brings the abutting contact portion 22c of the slide member 22 into contact with the retaining portion 20a of the upstream side holding portion 20. Thus, the crossing angle θ of the upper movable blade 13a to the lower movable blade 13b is minimized (crossing angle θ=θ1). At a crossing angle θ=θ1 where the crossing angle θ is minimized, cutting can be achieved such that the cutting surface of the rolled paper 1 being cut exhibits high quality, suppressing possible paper dust during the cutting.

In connection with movement of the cutter unit 12 in the cutting direction X1, the first flat surface 16a is arranged such that at least when the cutting point 15 of the cutter unit 12 is positioned at the cutting start point P2 where the cutting of the rolled paper 1 is started, the contact portion 22b comes into contact with the first flat surface 16a. Specifically, the first flat surface 16a is formed to extend from a position closer to the standby position P1 than the cutting start point P2 in the cutting direction to a position on the traveling direction side in the cutting direction with respect to the end of the rolled paper 1. Thus, the contact portion 22b remains in contact with the first flat surface 16a until the cutting point 15 reaches the cutting start point P2.

The slope portion 16c is arranged so as to extend from a position to which, during the cutting, the cutting point 15 of the cutter unit 12 moves a predetermined distance after passing through the cutting start point P2. In this regard, the predetermined distance is determined with a variation in the sheet end position of the rolled paper 1 taken into account and, for example, corresponds to one rotation of the upper movable blade 13a following the start of the cutting of the rolled paper 1. In the present embodiment, the predetermined distance is 5 to 80 mm from the cutting start point P2.

The slope portion 16c smoothly joins the first flat surface 16a and the second flat surface 16b together to suppress a rapid change in the position of the slide member 22, thus restraining damage to the upper movable blade 13a and the lower movable blade 13b caused by a rapid change in the crossing angle θ of the upper movable blade 13a. The slope portion 16c may be a flat surface or a curved surface as long as the slope portion 16c allows the first flat surface 16a and the second flat surface 16b to be smoothly joined together.

In the above description, the second flat surface 16b is retracted to the degree that, with the abutting contact portion 22c of the slide member 22 in contact with the retaining portion 20a of the upstream side holding portion 20, the contact portion 22b of the slide member 22 does not contact the second flat surface 16b. However, the present embodiment is not limited to this configuration. For example, the second flat surface 16b may be positioned to the degree that the abutting contact portion 22c of the slide member 22 contacts the second flat surface 16b, specifically, to the degree that the abutting contact portion 22c of the slide member 22 contacts the retaining portion 20a of the upstream side holding portion 20.

As described above, in the present embodiment, the crossing angle changing device 61 and the upstream support member 16 provided in the cutting apparatus 5 enable the crossing angle θ of the upper movable blade 13a to be changed while the rolled paper 1 is being cut. When the cutting of the rolled paper 1 is started (cutting start point P2), the crossing angle θ of the upper movable blade 13a is set to a large value because the blades have difficulty biting into the sheet. This allows the blades to appropriately bite into the sheet to prevent a situation where the sheet starts to be deformed at the position of abutting contact with the blades and is thus pushed in the cutting direction X1, resulting in inappropriate cutting. On the other hand, in the area corresponding to a time following the start of the cutting, the inappropriate cutting resulting from the pushing of the sheet in the cutting direction X1 is unlikely to occur. Thus, the crossing angle θ of the upper movable blade 13a is set to a small value to suppress degraded cutting quality such as a large amount of paper dust from the cutting surface or degraded durability of the blades.

As described above, the cutting apparatus of the present embodiment includes the crossing angle changing device that changes the crossing angle θ, which is the angle of the upper movable blade 13a to the lower movable blade 13b, while the cut medium is being cut. In the crossing angle changing device, the upstream support member 16 includes the first flat surface 16a and the second flat surface 16b. Before the cutter unit 12 performs cutting and when the cutter unit 12 is in the cutting start point P2, the slide member 22 contacts the first flat surface 16a and is pushed downstream in the conveying direction to tilt the upper movable blade rotating shaft 19a, increasing the crossing angle θ.

Thus, at the start of the cutting, the blades appropriately bite into the sheet to allow the cutting performance to be enhanced. During the cutting, the slide member 22 reaches the second flat surface 16b through the slope portion 16c and is slid toward the upstream side holding portion 20. Consequently, the crossing angle θ decreases to allow the quality of the cutting surface to be restrained from being degraded.

In the present embodiment, the first flat surface 16a extends from the position corresponding to a time preceding the start of the cutting to the position where the cutting point 15 of the cutter unit 12 reaches the cutting start point P2. However, the present embodiment is not limited to this configuration. For example, the first flat surface 16a may be formed at a position corresponding to a time immediately before the end of the cutting to increase the crossing angle θ to enhance the cutting performance. This configuration prevents a situation where the sheet above the sheet discharge guide 11 falls obliquely starting with a cutting start side of the sheet, to raise an uncut part of the sheet, resulting in inappropriate cutting. Alternatively, a flat surface with a protruding distance equivalent to the protruding distance of the first flat surface 16a may be provided in two areas including an area corresponding to an initial period of the cutting and an area corresponding to a time immediately before the end of the cutting. Thus, the protruding distance of the upstream support member 16 and the location of the upstream support member 16 are not limited to those in the present embodiment but may be freely set in order both to enhance the cutting performance and to ensure the cutting quality.

The downstream support member changes the pressing force exerted on the lower movable blade 13b by the upper movable blade 13a. The downstream support member 17 is arranged above the surface of the rolled paper 1 on which the image is printed. The downstream support member 17 controls the position of the external holder 27 via the pressing member 28 of the cutter unit 12 to change the pressing force exerted on the lower movable blade 13b by the upper movable blade 13a as depicted in FIG. 8. The downstream support member 17 has undulating surfaces, and has a first flat surface 17a that is a surface protruding in a direction opposite to the conveying direction orthogonal to the cutting direction X1, a second flat surface 17b retracted at a predetermined distance from the first flat surface 17a, and a slope portion 17c that joins the first flat surface 17a and the second flat surface 17b together.

The first flat surface 17a, which is a part of the undulating portion, protrudes to the degree that the thrust suppressing portion 28a of the pressing member 28 is pushed in and brought nearly into contact with the downstream side holding portion 21. That is, when the cutter unit 12 is in a position where the pressing member 28 is pushed in by the first flat surface 16a, the pressing force F exerted on the lower movable blade 13b by the upper movable blade 13a is maximized (pressing force F=F2).

At the start of the cutting, inappropriate cutting is likely to result from separation of the blades caused by cutting resistance from the sheet. Thus, near the end of the rolled paper 1, the pressing force F exerted on the lower movable blade 13b by the upper movable blade 13a is maximized in order to suppress inappropriate cutting. That is, at the start of the cutting, the upper movable blade 13a and the lower movable blade 13b are brought into contact with each other by a strong force near the end of the rolled paper 1.

The second flat surface 17b is retracted to the degree that, with the thrust suppressing portion 27a of the external holder 27 in contact with the downstream side holding portion 21, the pressing member 28 does not contact the second flat surface 17b. As depicted in FIG. 9, when the pressing member 28 is in a position corresponding to the second flat surface 17b in the cutting direction, the pressing member 28 does not contact the second flat surface 17b and is thus not pushed in. When the cutter unit 12 is in this position, the pressing force F exerted on the lower movable blade 13b is minimized (pressing force F=F1). The minimized pressing force F exerted on the lower movable blade 13b restrains the durability of the upper movable blade 13a and the lower movable blade 13b from being degraded as a result of the wear of the blades.

In connection with movement of the cutter unit 12 in the cutting direction X1, the first flat surface 17a is arranged such that at least when the cutting point 15 of the cutter unit 12 reaches the cutting start point P2 where the cutting of the rolled paper 1 is started, the pressing member 28 comes into contact with the first flat surface 17a and is pushed a predetermined distance by the first flat surface 17a. Specifically, the first flat surface 17a is provided so as to extend from a position closer to the standby position P1 than the cutting start point P2 in the cutting direction to a position slightly closer to the standby position than the end of the rolled paper 1 in the cutting direction. Thus, the pressing member 28 remains in contact with the first flat surface 17a until the cutting point 15 reaches the cutting start point P2.

The slope portion 16c is arranged so as to extend from a position to which, during the cutting, the cutter unit 12 has moved a predetermined distance after passing through the cutting start point P2. The slope portion 17c smoothly joins the first flat surface 17a and the second flat surface 17b together to suppress a rapid change in the position of the external holder 27 via the pressing member 28, thus restraining damage to the upper movable blade 13a and the lower movable blade 13b caused by a rapid change in the pressing force F.

The slope portion 17c may be a flat surface or a curved surface as long as the slope portion 17c allows the first flat surface 17a and the second flat surface 17b to be smoothly joined together. In the above description, the second flat surface 17b is retracted to the degree that, with the thrust suppressing portion 27a of the external holder 27 in contact with the downstream side holding portion 21, the pressing member 28 does not contact the second flat surface 17b. However, the present embodiment is not limited to this configuration. For example, the second flat surface 17b may be positioned to the degree that the thrust suppressing portion 27a of the external holder 27 contacts the downstream side holding portion 21.

As described above, the pressing force changing device 62 and the downstream support member 17 provided in the cutting apparatus 5 enable the pressing force F exerted on the lower movable blade 13b to be changed while the rolled paper 1 is being cut. That is, near the cutting start point of the rolled paper 1 where the blades have difficulty biting into the sheet, the pressing force exerted on the lower movable blade 13b is set to a large value. This allows the blades to more reliably contact each other, suppressing possible inappropriate cutting resulting from separation of the blades caused by cutting resistance from the sheet. On the other hand, in an area corresponding to a time following the start of the cutting, the inappropriate cutting resulting from separation of the blades is unlikely to occur. Thus, the pressing force F exerted on the lower movable blade 13b is set to a small value to suppress degraded durability resulting from the wear of the blades.

In the present embodiment, the first flat surface 17a extends from a position corresponding to time preceding the start of the cutting to a position where the cutting point 15 reaches the cutting start point P2. The first flat surface 17a may be formed at a position corresponding to a time immediately before the end of the cutting to increase the pressing force F to enhance the cutting performance. This configuration prevents a situation where the sheet above the sheet discharge guide 11 falls obliquely starting with the cutting start side of the sheet, to raise the uncut part of the sheet, resulting in inappropriate cutting.

The rack member changes the peripheral speed of the lower movable blade 13b. The rack member 41 is provided on the guide rail 10, and meshes with and forcibly rotates the lower movable blade 13b via a plurality of gears to change the peripheral speed of the lower movable blade 13b as depicted in FIG. 6. The rack member 41 is arranged such that at least at the cutting start point P2 where the cutter unit 12 starts cutting the rolled paper 1, the rotation input gear 40a meshes with the rack member 41 to forcibly rotate the lower movable blade 13b as depicted in FIG. 6. That is, at the cutting start point P2 where cutting is started, the rotation input gear 40a (pinion gear) meshes with the rack member 41 to make the peripheral speed V2 of the lower movable blade 13b higher than the cutting speed V1 corresponding to the moving speed of the cutter unit 12.

The peripheral speed V2 of the lower movable blade 13b is increased to allow the blades to appropriately bite into the sheet at the start of the cutting. This suppresses a situation where the sheet starts to be deformed at the position of abutting contact with the blades and is thus pushed in the cutting direction X1, resulting in inappropriate cutting. In the present embodiment, the rack member 41 is arranged so as to extend from the standby position P1, from which the cutter unit 12 moves, through the cutting start point P2 to a position where the cutter unit 12 has cut the rolled paper 1 by a predetermined length. In the present embodiment, the predetermined length is set with a variation in the sheet end position of the rolled paper 1 taken into account. For example, the predetermined length corresponds to an amount of time from the start of cutting of the rolled paper 1 by the upper movable blade 13a until the upper movable blade 13a has made one rotation, that is, 5 to 80 mm. The cutting over this distance is defined as an initial cutting operation.

As the cutter unit 12 further moves in the cutting direction X1, the cutter unit 12 encounters an area where the rack member 41 is not provided, as depicted in FIG. 7. That is, the rotation input gear 40a does not mesh with the rack member 41. Thus, when the rolled paper 1 is cut, the lower movable blade 13b is rotated by the frictional force between the lower movable blade 13b and the rolled paper 1. At this time, the peripheral speed V2 is approximately equal to the cutting speed V1 corresponding to the moving speed of the cutter unit 12. When the rolled paper 1 is not cut (during a moving operation following the end of the cutting or the like), the peripheral speed V2 of the lower movable blade 13b is zero. Consequently, the upper movable blade 13a and the lower movable blade 13b do not rotate relative to each other.

In the present embodiment, the rack member 41 rotates the lower movable blade 13b. However, the present embodiment is not limited to this configuration. The upper movable blade 13a may be rotated or both the upper movable blade 13a and the lower movable blade 13b may be rotated.

As described above, when the rotary-blade rotating device installed in the cutting apparatus 5 is provided on a part of the guide rail 10, it is possible to set the area where one of the movable blades is forcibly rotated while the rolled paper 1 is being cut and the area where neither of the movable blades are rotated while the rolled paper 1 is being cut. This enables the peripheral speed V2 of the lower movable blade 13b to be changed. In the present embodiment, near the cutting start point of the rolled paper 1 where the blades have difficulty biting into the sheet, the rack member 41 is provided to set a high peripheral speed V2 for the lower movable blade 13b to allow the blades to approximately bite into the sheet. This suppresses a situation where the sheet starts to be deformed at the position of abutting contact with the blades and is thus pushed in the cutting direction X1, resulting in inappropriate cutting.

On the other hand, in an area corresponding to a time following the start of the cutting, the inappropriate cutting resulting from pushing of the sheet in the cutting direction X1 is unlikely to occur. Thus, the rack member 41 is omitted to make the peripheral speed V2 approximately equal to the cutting speed to suppress degraded cutting quality such as a large amount of paper dust from the cutting surface or degraded durability of the blades. Moreover, in an area where the sheet is not cut, the peripheral speed V2 of the lower movable blade 13b is zero, and the blades are protected from wear resulting from the relative rotation of the blades. This restrains the durability of the upper movable blade 13a and the lower movable blade 13b from being degraded.

In the present embodiment, the cutting apparatus changes the relative speed of the cutting edge of the blade member with respect to the cut medium as described above. The rack member rotating the rotary blade is provided in a part of the movement area of the cutter unit 12 to change the peripheral speed of the lower movable blade 13b, which is the speed of the cutting edge of the blade member relative to the cut medium. Specifically, near the cutting start point, the rotary blade is forcibly rotated via the rack member to increase the peripheral speed of the lower movable blade 13b to allow the blades to appropriately bite into the sheet, thus enhancing the cutting performance.

During the cutting, the forced rotation via the rack member is not executed, and the peripheral speed is set lower than the peripheral speed near the cutting start point and approximately equal to the cutting speed. This allows suppression of degraded cutting quality such as a large amount of paper dust from the cutting surface and degraded durability. Furthermore, for example, during an operation in which the cutter unit 12 returns after the cutting, no force that rotates the upper movable blade 13a and the lower movable blade 13b is exerted, and the peripheral speed is zero. The blades are thus precluded from rotating. Consequently, the blades are protected from wear resulting from the relative rotation of the blades, suppressing degraded durability of the blades.

In the present embodiment, the peripheral speed of the lower movable blade 13b near the cutting start point is twice as high as the cutting speed, which is the moving speed of the cutter unit 12. However, the present embodiment is not limited to this configuration. The peripheral speed may allow the blades to appropriately bite into the sheet. Furthermore, in the present embodiment, the area where the peripheral speed of the lower movable blade 13b is changed is positioned 5 to 80 mm away from the cutting start point with misalignment of the sheet taken into account. However, the present embodiment is not limited to this configuration. The area may be any area beyond a position corresponding to a time when the blades bite into the sheet and may be optionally set. In the present embodiment, the upper movable blade 13a is configured to be rotated in conjunction with rotation of the lower movable blade 13b. However, a configuration is possible in which the upper movable blade 13a can also be forcibly rotated and in which the peripheral speed of the upper movable blade 13a is changed by forcibly rotating the rotary blade at least near the cutting start point.

In the present embodiment, the area where the lower movable blade 13b is forcibly rotated and the area where the lower movable blade 13b is not rotated are formed depending on whether or not the rack member 41 is provided. However, the present embodiment is not limited to this configuration. For example, a rack and gears different from the rack and gears in the present embodiment may be provided and an area where the gears mesh with the rack may be formed such that the peripheral speed of the blade member is changed at a plurality of stages.

In the present embodiment, the configuration has been described in which the lower movable blade is forcibly rotated. However, the present embodiment is not limited to this configuration. The upper movable blade may be forcibly rotated.

As described above, in the present embodiment, the cutting apparatus includes the peripheral speed changing device that changes the speed of the cutting edge of the blade member relative to the cut medium while the cut medium is being cut as described above. Thus, a cutting apparatus and a printing apparatus can be provided which allow suppression of degraded cutting quality and degraded durability of the rotary blades, while suppressing possible inappropriate cutting.

In the present embodiment, the crossing angle between the two blades is changed during the cutting operation to enable enhancement of the cutting performance at the start of the cutting and suppression of generation of paper dust as a result of the cutting.

In the present embodiment, the angle of one blade of the pair of blades is changed to allow for a change in the crossing angle between the two blades. At this time, instead of the shaft of the one blade (upper movable blade rotating shaft 19a) itself, the slide member 22 supporting the shaft is moved in a direction crossing the cutting direction (in the present embodiment, a direction substantially perpendicular to the cutting direction). Thus, the accuracy of change of the crossing angle can be improved regardless of a reaction force from the paper or the like.

In the present embodiment, the sliding distance of the slide member 22 pivotally supporting the upper movable blade rotating shaft 19a is adjusted using the groove portion 22a formed in the upstream side holding portion 20 and the groove portion 21b formed in the downstream side holding portion 21. Thus, the sliding distance can be accurately managed. Furthermore, the cutting apparatus in the present embodiment uses the circular blades both of which are rotatable and is thus advantageous compared to cutting apparatuses using knife-like blades. That is, the circular blades provide an appropriate cut end surface, enable a variety of print media to be cut, and have long lives. Furthermore, compared to fixed blades one of which is elongate, the circular blades needs lower costs and a smaller space.

In the present embodiment, the cutting speed for the rolled paper 1 during the cutting operation is constant. However, the present embodiment is not limited to this configuration. For example, the cutting speed may be low at the start of the cutting of the rolled paper 1 and may be high during the cutting.

### Second Embodiment

A second embodiment will be described below with reference to the drawings. A basic configuration of the present embodiment is similar to the basic configuration of the first embodiment. Thus, only characteristic parts of the configuration will be described below. A modification of the rotary-blade rotating device serving as a blade member driving device is illustrated below. However, the same components as those of the first embodiment are denoted by the same reference numerals and will not be described below.

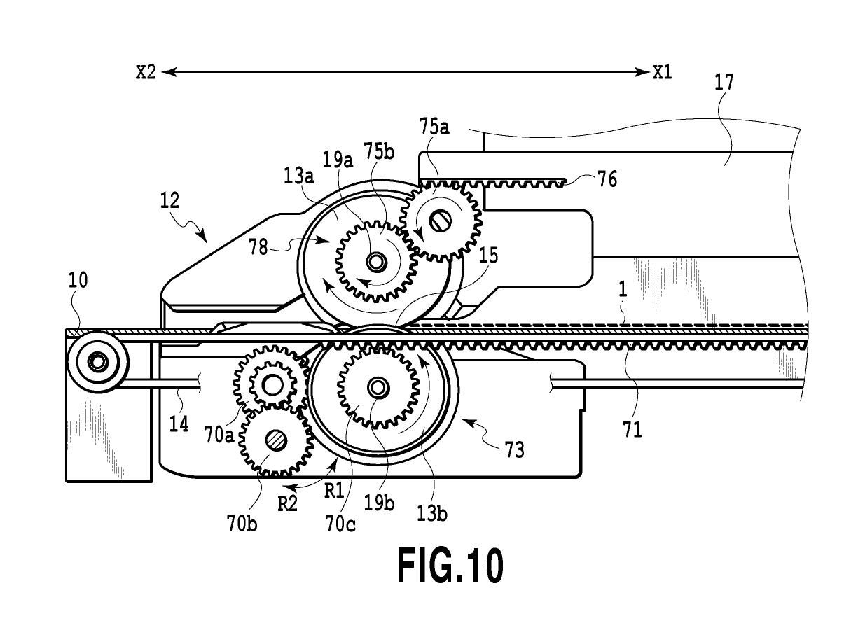

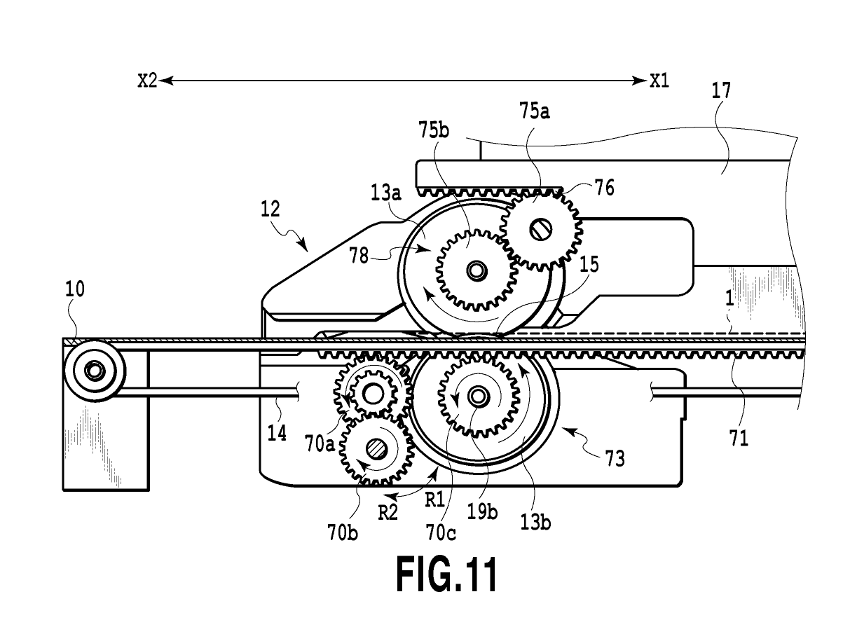

FIG. 10 is a schematic sectional view illustrating that the cutter unit 12 is in the cutting start point position as seen from behind. FIG. 11 is a schematic sectional view illustrating that the cutter unit is performing cutting as seen from behind and depicting a state where the cutter unit 12 in the state depicted in FIG. 10 has further moved in the cutting direction X1. With reference to FIG. 10 and FIG. 11, a series of operations will be described in which the rotary-blade rotating device changes the peripheral speed of the rotary blade. The present embodiment is configured such that, in addition to the lower movable blade 13b, the upper movable blade 13a can be forcibly rotated.

The blade member driving device includes an upper-movable-blade rotating device 78, a lower-movable-blade rotating device 73, and a driving section (not depicted in the drawings) that operates the cutter unit 12 such that the cutter unit 12 is able to reciprocate along the guide rail 10. The upper movable blade rotating device 78 has an upper-movable-blade rotation input gear 75a and a lower-movable-blade rotation input gear 75b. The upper-movable-blade rotation input gear 75a meshes with and moves relative to an upper-movable-blade rack member 76 to forcibly rotate the upper movable blade 13a.

The lower-movable-blade rotating device 73 has a lower-movable-blade rotation input gear 70a, a lower-movable-blade pendulum gear 70b, and a lower-movable-blade rotating gear 70c. The lower-movable-blade rotation input gear 70a is a two-stage gear with different outer diameters meshes with and moves relative to a lower-movable-blade rack member 71 to forcibly rotate the lower movable blade 13b. In the present embodiment, the lower-movable-blade rotation input gear 70a is a two-stage gear. However, the lower-movable-blade rotation input gear 70a may be a multi-stage gear.

The lower-movable-blade pendulum gear 70b is configured to be able to rotationally move around the lower-movable-blade rotation input gear 70a. When the lower-movable-blade rotation input gear 70a moves in the direction of an arrow in FIG. 11, the lower-movable-blade pendulum gear 70b rotates around the lower-movable-blade rotation input gear 70a in a direction R1 to a position where the lower-movable-blade pendulum gear 70b meshes with the lower-movable-blade rotating gear 70c. The lower-movable-blade pendulum gear 70b thus transmits rotation to the lower-movable-blade rotating gear 70c.

When the lower-movable-blade rotation input gear 70a rotates in a direction opposite to the direction of the arrow in FIG. 11, the lower-movable-blade pendulum gear 70b rotates around the lower-movable-blade rotation input gear 70a in a direction R2 and is stopped at a position depicted in FIG. 10, by a stopper not depicted in the drawings. In this state, the lower-movable-blade pendulum gear 70b dos not mesh with the lower-movable-blade rotating gear 70c, and rotation of the lower-movable-blade pendulum gear 70b is not transmitted to the lower-movable-blade rotating gear 70c. As described above, the lower-movable-blade pendulum gear 70b enables switching between the transmission of rotation of the lower-movable-blade rotation input gear 75b to the lower-movable-blade rotating gear 70c and the disconnection of the lower-movable-blade rotation input gear 70a from the lower-movable-blade rotating gear 70c.

The upper-movable-blade rack member 76 is arranged such that, at least at the cutting start point P2 where the cutter unit 12 starts cutting the rolled paper 1, the upper-movable-blade rotation input gear 75a meshes with the upper-movable-blade rack member 76. Upon meshing with the upper-movable-blade rack member 76 at the cutting start point P2 where the cutter unit 12 starts cutting the rolled paper 1, the upper-movable-blade rotation input gear 75a is forcibly rotated in conjunction with movement of the cutter unit 12 to transmit the rotation to the upper-movable-blade rotating gear 75b.

To rotate integrally with the upper movable blade 13a, the upper-movable-blade rotating gear 75b uses the upper-movable-blade rotating shaft 19a as a central shaft and is integrally attached to the upper movable blade 13a. Therefore, forcible rotation of the upper-movable-blade rotating gear 75b also rotates the upper movable blade 13a. In the present embodiment, the peripheral speed V2 of the upper movable blade 13a in this area is approximately 2×V1, that is, approximately twice as high as the cutting speed V1 corresponding to the moving speed of the cutter unit 12 as is the case with the first embodiment.

In this area, the lower movable blade 13b is rotated in conjunction with rotation of the upper movable blade 13a as a result of friction between the lower movable blade 13b and the upper movable blade 13a. Thus, the peripheral speed V2 of the lower movable blade 13b is set lower than the peripheral speed V2 of the upper movable blade 13a and higher than the cutting speed V1 corresponding to the moving speed of the cutter unit 12.

The lower-movable-blade rack member 71 is arranged such that the lower-movable-blade rotation input gear 70a remains meshed with the lower-movable-blade rack member 71 at least from a position corresponding to a time after the cutter unit 12 passes through the cutting start point P2 to a position where the cutting operation for the rolled paper 1 in the cutting direction X1 ends. The lower-movable-blade rotation input gear 70a meshes with the lower-movable-blade rack member 71 after the cutter unit 12 passes through the cutting start point P2, and is then forcibly rotated in conjunction with movement of the cutter unit 12 to transmit rotation to the lower-movable-blade pendulum gear 70b. At this time, the lower-movable-blade pendulum gear 70b meshes with the lower-movable-blade rotating gear 70c to transmit rotation of the lower-movable-blade pendulum gear 70b to the lower-movable-blade rotating gear 70c.

To rotate integrally with the lower movable blade 13b, the lower-movable-blade rotating gear 70c uses the lower-movable-blade rotating shaft 19b as a central shaft and is integrally attached to the lower movable blade 13b. Forcible rotation of the lower-movable-blade rotating gear 70c also rotates the lower movable blade 13b. When the lower-movable-blade rotation input gear 70a is a stepped gear with a speed ratio of 1/2 and the cutting speed corresponding to the moving speed of the cutter unit 12 is denoted as V1, the peripheral speed of the lower-movable-blade pendulum gear 70b is approximately half the cutting speed V1.

The peripheral speed V2 of the lower movable blade 13b is set approximately twice as high as the peripheral speed of the lower-movable-blade rotating gear 70c as is the case with the first embodiment. Thus, the peripheral speed V2 of the lower movable blade 13b in this area is approximately equal to the cutting speed V1 corresponding to the moving speed of the cutter unit 12. In this area, the upper movable blade 13a is rotated in conjunction with cutting of the rolled paper 1 or with rotation of the lower movable blade 13b as a result of friction between the upper movable blade 13a and the lower movable blade 13b. Consequently, the upper movable blade 13a is configured to rotate at the peripheral speed V2 approximately equal to the cutting speed V1 corresponding to the moving speed of the cutter unit 12.

As described above, near the cutting start point for the cutting operation in the cutting direction X1 by the cutter unit 12, the upper-movable-blade rotating device 78 and the upper-movable-blade rack member 76 allow the upper movable blade 13a to rotate at a peripheral speed approximately twice as high as the cutting speed V1 corresponding to the moving speed of the cutter unit 12. The peripheral speed V2 of the lower movable blade 13b during rotation is also set higher than the cutting speed V1 corresponding to the moving speed of the cutter unit 12. During the cutting, the lower-movable-blade rotating device 73 and the lower-movable-blade rack member 71 allow the lower movable blade 13b to rotate at a peripheral speed approximately equal to the cutting speed V1 corresponding to the moving speed of the cutter unit 12. The peripheral speed V2 of the upper movable blade 13a during rotation is also set equal to the cutting speed V1 corresponding to the moving speed of the cutter unit 12.

On the other hand, during an operation in which the cutter unit 12 returns in the direction X2 after the cutting operation, the lower-movable-blade rotation input gear 70a and the lower-movable-blade pendulum gear 70b rotate but the pendulum configuration prevents the lower-movable-blade pendulum gear 70b from meshing with the lower-movable-blade rotating gear 70c. Thus, during the returning operation, the lower-movable-blade rotating gear 70c does not rotate. In an area being cut during the returning operation in the direction X2, neither the upper movable blade 13a nor the lower movable blade 13b rotates.

As described above, in the present embodiment, the upper-movable-blade rotating device serving as the blade member driving device and the lower-movable-blade rotating device change the peripheral speed of each of the upper and lower movable blades corresponding to the speed of the cutting edge of the blade member relative to the cut medium while the cut medium is being cut. Near the cutting start point, the upper-movable-blade rotating device forcibly rotates the upper movable blade and the lower movable blade such that the peripheral speed is higher than the cutting speed. This allows the blades to appropriately bite into the sheet at the start of the cutting, enabling the cutting performance to be enhanced.

During the cutting, the lower-movable-blade rotating device forcibly rotates the lower movable blade and the upper movable blade such that the peripheral speed is equal to the cutting speed. This enables the lower movable blade to rotate stably, allowing enhancement of the cutting performance and suppression of degraded cutting quality such as a large amount of paper dust from the cutting surface and degraded durability. In an area corresponding to the returning operation of the cutter unit and not contributing to cutting, the forced rotation performed by the upper-movable-blade rotating device is prevented from being transmitted to the lower movable blade.

Thus, no force that rotates the upper movable blade and the lower movable blade is exerted, and the peripheral speed is zero. Consequently, the blades are protected from wear resulting from relative rotation of the blades, allowing suppression of degraded durability.

In the present embodiment, the upper movable blade is forcibly rotated near the cutting start point, and the lower movable blade is forcibly rotated during the cutting. However, the embodiment may be configured such that the lower movable blade is forcibly rotated near the cutting start point, while the upper movable blade is forcibly rotated during the cutting. Furthermore, the peripheral speed for the vicinity of the cutting start point and the area where the peripheral speed is changed may be optionally set as is the case with the first embodiment.

As mentioned above, the present invention allows suppression of degraded cutting quality and degraded durability of the rotary blade while restraining possible inappropriate cutting.

### Other Embodiments

In the above-described embodiments, after the cutting point 15 of the cutter unit 12 passes through the cutting start point P2 and then moves a predetermined distance (the distance corresponding to one rotation of the upper movable blade 13a following the start of the cutting), the contact portion 22b is placed in the position corresponding to the slope portion 16c, and the pressing member 28 is placed in the position corresponding to the slope portion 16c. However, the present invention is not limited to this embodiment. A timing when the contact portion 22b reaches the slope portion 16c may be different from a timing when the pressing member 28 reaches the slope portion 16c.

In the above-described embodiments, the serial ink jet printing apparatus has been described. However, the embodiments are applicable to what is called a line head printing apparatus in which nozzles in a print head are arranged in juxtaposition in a direction orthogonal to the sheet conveying direction (sheet width direction). Furthermore, the printing scheme is not limited to image printing based on the ink jet scheme using a liquid ink for image printing. A solid ink may be used as a print agent, and various schemes such as an electrophotographic scheme using toner and a sublimation scheme may be adopted. Additionally, the present invention is not limited to color printing using print agents in a plurality of colors, but monochrome printing using only black (including gray) may be performed.

In the above-described embodiments, the printing apparatus with the cutting apparatus has been described. However, the embodiments can also be applied to a configuration only with the cutting apparatus.

The configuration has been described in which the movable-blade rotating device serving as the blade member driving device changes the peripheral speed of the movable blade corresponding to the speed of the cutting edge of the blade member relative to the cut medium. However, as the configuration that changes the peripheral speed, the present invention is also applicable to a configuration that changes the moving speed of the cutter unit.

The movable-blade rotating device serving as the blade member driving device may be configured to change the peripheral speed of the movable speed corresponding to the speed of the cutting edge of the blade member relative to the cut medium. The present invention is also applicable to, for example, a configuration that forcibly rotates the movable blade using a motor.

The cutter unit in which the upper movable blade and the lower movable blade are disc-like circular blades has been described. However, the present invention is applicable to a cutter unit including a circular blade and an elongate fixed blade and in which the peripheral speed of the circular blade is changed.

Besides paper, plastic sheets, photographic printing paper, cloths, and the like, a variety of sheet-like materials may be used as cut media. In the above description, the rolled paper has been taken as an example of the cut medium cut by the cutting apparatus. However, the present invention is not limited to rolled cut media. Continuous sheets that are not rolled and the like may be used, and any media that can be cut by the cutting apparatus may be used.

The configuration that cuts the cut medium by moving the cutter unit has been described. However, the present invention is applicable to a cutting apparatus configured to cut the cut medium by moving the cut medium instead of moving the cutter unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-183373, filed Sep. 9, 2014, which is hereby incorporated by reference wherein in its entirety.

What is claimed is:

1. A cutting apparatus comprising:
a cutting unit with a rotary blade configured to cut an object by relatively moving an object and the rotary blade to each other in a cutting direction; and
a changing unit configured to change a peripheral speed of the rotary blade while the object is being cut,
wherein the changing unit sets the peripheral speed of the rotary blade during a first cutting operation from a start of cutting of the object until the object has been cut by a predetermined length, to be higher than the peripheral speed of the rotary blade during a second cutting operation in which the object is cut after the first cutting operation.

2. The cutting apparatus according to claim 1, wherein the changing unit changes the peripheral speed of the rotary blade such that the peripheral speed of the rotary blade is higher than a cutting speed for the object during the first cutting operation and is approximately equal to the cutting speed for the object during the second cutting operation.

3. The cutting apparatus according to claim 2, wherein the cutting speed is constant.

4. The cutting apparatus according to claim 1, wherein the blade member comprises a first blade member and a second blade member that cooperates with the first blade member in cutting the object.

5. The cutting apparatus according to claim 4, wherein the first blade member and the second blade member are rotary blades provided so as to be rotatable.

6. The cutting apparatus according to claim 5, wherein the changing unit changes the peripheral speed of at least one of the first blade member and the second blade member.

7. The cutting apparatus according to claim 1, wherein the changing unit changes the peripheral speed of the rotary blade by action of a rack and a pinion gear.

8. The cutting apparatus according to claim 7, further comprising
a stepped gear including a first gear that meshes with the rack and a second gear having a smaller outer diameter than the first gear;
a third gear configured to mesh with the second gear of the stepped gear and to be rotationally movable around the second gear; and
a fourth gear formed integrally with one of the first and second blade members,
wherein the third gear rotationally moves around the second gear to switch between transmission of rotation of the stepped gear to the fourth gear and disconnection of the fourth gear from the stepped gear.

9. The cutting apparatus according to claim 8, wherein when the blade member moves in a direction opposite to the cutting direction, the third gear and the fourth gear do not mesh with each other, and rotation of the

[symbol]

10. A printing apparatus comprising:
an image printing unit configured to print an image on the object;
a cutting unit with a rotary blade configured to cut an object by relatively moving an object and the rotary blade to each other in a cutting direction; and
a changing unit configured to change a peripheral speed of the rotary blade while the object is being cut,
wherein the changing unit sets the peripheral speed of the rotary blade during a first cutting operation from a start of cutting of the object until the object has been cut by a predetermined length, to be higher than the peripheral speed of the rotary blade during a second cutting operation in which the object is cut after the first cutting operation.
